(19) United States
(12) Patent Application Publication
(10) Pub. No.: US 2002/0143586 A1
(43) Pub. Date: Oct. 3, 2002

(54) Apparatus and method for supporting insurance determination, and program thereof

(76) Inventors: Ryuichiro Kodama, Tokyo (JP); Michiaki Mori, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 10/063,163

(22) Filed: Mar. 27, 2002

(30) Foreign Application Priority Data
Mar. 29, 2001 (JP) 2001-095523

(51) Int. Cl. G06F 17/60

(52) U.S. Cl. 705/4

(57) ABSTRACT

An apparatus for supporting a user in determining insurance to compensate for damage to an object of the insurance. A compensation-request-acquiring unit acquires compensation request information that has a correlation with an expectation of the user for compensation for damage caused on the insured object. A premium-distribution unit distributes premium for the insured object using the compensation request information acquired by the compensation-request-acquiring unit.

### CROSS REFERENCE TO RELATED APPLICATIONS

This patent application claims priority from a Japanese patent application No. 2001-095523 filed on Mar. 29, 2001, the contents of which are incorporated herein by reference.

### BACKGROUND OF INVENTION

1. Field of the Invention

The present invention relates to an insurance-determination-supporting apparatus, a method for supporting insurance determination, and a program thereof. More particularly, the present invention relates to an insurance-determination-supporting apparatus, a method for supporting insurance determination, and a program thereof that support a customer accurately distributing insurance premium to a plurality of insured objects.

2. Description of the Related Art

Conventionally, when a customer carries insurance for a plurality of insured objects, the customer has to examine each insurance and conclude a contract for each insurance separately.

However, it is difficult to properly distribute the insurance premium for a plurality of insured objects by the above-mentioned method. Furthermore, when damage is caused to a plurality of insured objects by the same cause, the insurance money was paid from each insurance carried by the customer. Therefore, sometimes a customer feels that he carries too much insurance.

### SUMMARY OF INVENTION

Therefore, it is an object of the present invention to provide an apparatus and a method for supporting insurance determination, and a program thereof, capable of overcoming the above drawbacks accompanying the conventional art. The above and other objects can be achieved by combinations described in the independent claims. The dependent claims define further advantageous and exemplary combinations of the present invention.

According to a first aspect of the present invention, an apparatus for supporting a user in determining insurance to compensate for damage to an object of the insurance, comprises a compensation-request-acquiring unit for acquiring compensation request information that has a correlation with an expectation of the user for compensation for damage caused on the insured object; and a premium-distribution unit for determining a distribution of premium for the insured object using the compensation request information acquired by the compensation-request-acquiring unit.

The apparatus may further comprise a payment-limit-amount calculation unit for calculating a payment-limit-amount for the insured object using the distribution of the premium determined by the premium-distribution unit. The apparatus may further comprise a premium rate database that stores a premium rate of a plurality of the insured objects; and the payment-limit-amount calculation unit calculates the payment-limit-amount for the plurality of the insured objects using the distribution of the premium and the premium rate stored in the premium rate database.

The apparatus may further comprise a total limit amount setting unit for setting a total limit amount, which is an upper limit of insurance money to be paid for a plurality of the insured objects because of a same cause when there are the plurality of the insured objects; and a premium-changing unit for changing each distributed premium for the plurality of the insured objects using the total limit amount set by the total limit amount setting unit when there are the plurality of the insured objects.

The premium changing unit may acquire a ratio between a first expected value of insurance money, which is paid when the total limit amount is applied, and a second expected value of insurance money, which is paid when the total limit amount is not applied, and change the premium using the ratio.

The apparatus may further comprise an information-transmission-urging unit that displays a screen for urging the user to transmit conscience information, which is used to specify the expectation of the user for the insured object; and a conscience-information-acquiring unit for acquiring the conscience information from the user; and the compensation-request-acquiring unit acquires the compensation request information using the conscience information of the user.

The information-transmission-urging unit may display a questionnaire related to the insured object on the first screen and displays a second screen that urges the user to transmit an answer for the questionnaire; and the conscience-information-acquiring unit may receive the answer for the questionnaire as the conscience information.

The information-transmission-urging unit may use risk examples that describe examples of damages to the insured object as the questionnaire; and the conscience-information-acquiring unit may receive rank information that ranks the risk examples according to a degree of importance of each risk as the answer.

The information-transmission-urging unit may use risk examples that describe examples of damages to the insured object as the questionnaire; and the conscience-information-acquiring unit may receive evaluation information that evaluates a degree of importance of the risk examples as the answer.

The conscience-information-acquiring unit may acquire an expected occurrence frequency, which is a frequency of occurrence of an insurance accident estimated by the user, and an expected damage amount estimated by the user for one insurance accident, as the conscience information; and the compensation-request-acquiring unit may acquire the compensation request information using the expected occurrence frequency and the expected damage amount.

The conscience-information-acquiring unit may further acquire an expected action, which is expected to be performed by the user related to the insured object after the insurance accident happens; and the compensation-request-acquiring unit may acquire the compensation request information using the expected action.

According to a second aspect of the present invention, an apparatus for supporting a user to determine insurance, comprises: a value-acquiring unit for acquiring value information that indicates a value of an insured object; and a premium-distribution unit for determining a distribution of premium for the insured object using the value acquired by the value-acquiring unit. The apparatus may further comprise a payment-limit-amount calculation unit for calculating a payment-limit-amount for the insured object from the distributed premium.

The apparatus may further comprise a premium rate database that stores a premium rate of a plurality of the insured objects; and the payment-limit-amount calculation unit calculates the payment-limit-amount for the plurality of the insured objects using the distribution of the premium and the premium rate stored in the premium rate database.

The payment-limit-amount calculation unit may adjust the payment-limit-amount to the value of the insured object when the payment-limit-amount calculated by the payment-limit-amount calculation unit is greater than the value of the insured object; and the premium-distribution unit may deduct an excess premium, which corresponds to an amount of the payment-limit-amount that is reduced, from the premium of the insured object, when the payment-limit-amount calculation unit judges that the payment-limit-amount calculated by the payment-limit-amount calculation unit is greater than the value of the insured object.

The premium-distribution unit may redistribute the deducted amount of the excess premium to other insured objects, except the insured object, according to a ratio of the premium that has already been distributed, when there are a plurality of the insured objects.

The apparatus may further comprise a total limit amount setting unit for setting a total limit amount, which is an upper limit of insurance money to be paid for a plurality of the insured objects because of a same cause, when there are the plurality of the insured objects; and a premium-changing unit for changing each distributed premium of the plurality of the insured objects using the total limit amount set by the total limit amount setting unit, when there are the plurality of the insured objects.

The premium-changing unit may acquire a ratio between a first expected value of insurance money, which is to be paid when the total limit amount is applied, and a second expected value of insurance money, which is to be paid when the total limit amount is not applied, and change the premium using the ratio.

According to a third aspect of the present invention, an apparatus for supporting a user to determine insurance, comprises a value-acquiring unit for acquiring value information that indicates a value of an insured object; a compensation-request-acquiring unit for acquiring compensation request information that has a correlation with an expectation of the user for compensation for damage caused to the value of the insured object; and a premium-distribution unit for determining a distribution of premium for the insured object using the value acquired by the value-acquiring unit and the compensation request information acquired by the compensation-request-acquiring unit.

The apparatus may further comprise a payment-limit-amount calculation unit for calculating a payment-limit-amount for the insured object from the distributed premium. The payment-limit-amount calculation unit may adjust the payment-limit-amount to the value of the insured object when the payment-limit-amount calculated by the payment-limit-amount calculation unit is greater than the value of the insured object; and the premium-distribution unit may deduct an excess premium, which corresponds to an amount of the payment-limit-amount that is reduced, from the premium of the insured object, when the payment-limit-amount calculation unit judges that the payment-limit-amount calculated by the payment-limit-amount calculation unit is greater than the value of the insured object.

According to a fourth aspect of the present invention, a premium distribution adjusting apparatus for adjusting a distribution of corresponding premiums of a plurality of insured objects, comprises a value-acquiring unit for acquiring value information, which indicates a value of an insured object, for the plurality of the insured objects; a payment-limit-amount calculation unit for adjusting corresponding payment-limit-amounts of the plurality of the insured objects to the corresponding values of the insured objects when the payment-limit-amounts of the insured objects are greater than the values of the insured objects; and a premium-distribution unit for adjusting the distribution of premiums of the plurality of the insured objects according to the adjusted payment-limit-amounts.

According to a fifth aspect of the present invention, a method for supporting a user to determine insurance, comprises acquiring compensation request information that has a correlation with an expectation of the user for compensation for damage caused to an insured object; determining a distribution of premium for the insured object using the compensation request information; and notifying the distributed premium to the user. The method may further comprise calculating a payment-limit-amount for the insured object using the distribution of the premium.

The method may further comprise storing a premium rate of a plurality of the insured objects; and calculating the payment-limit-amount for the plurality of the insured objects using the distribution of the premium and the stored premium rate.

The method may further comprise setting a total limit amount, which is an upper limit of insurance money to be paid for a plurality of the insured objects because of a same cause when there are the plurality of the insured objects; and changing each distributed premium for the plurality of the insured objects using the total limit amount, when there are the plurality of the insured objects.

The method may further comprise displaying a screen for urging the user to transmit conscience information, which is used for specifying the expectation of the user for the insured object; and acquiring the conscience information from the user; and acquiring the compensation request information using the conscience information of the user.

According to a sixth aspect of the present invention, a method for supporting a user to determine insurance, comprises acquiring value information that indicates a value of an insured object; determining a distribution of premium for the insured object using the value; and notifying the distributed premium to the user. The method may further comprise calculating a payment-limit-amount for the insured object from the distributed premium. The method may further comprise storing a premium rate of a plurality of the insured objects; and calculating the payment-limit-amount for the plurality of the insured objects using the distribution of the premium and the stored premium rate.

The method may further comprise setting a total limit amount, which is an upper limit amount of insurance money to be paid for a plurality of the insured objects because of a same cause when there are the plurality of the insured objects; and changing each distributed premium for the plurality of the insured objects using the total limit amount, when there are the plurality of the insured objects.

According to a seventh aspect of the present invention, a storing medium storing a program executable by a computer for supporting a user to determine insurance, comprises a compensation request acquiring module for enabling the computer to acquire compensation request information that has a correlation with an expectation of the user for compensation for damage caused on an insured object; and a premium distribution module for enabling the computer to determine a distribution of premium for the insured object using the compensation request information.

According to an eighth aspect of the present invention, a storing medium storing a program executable by a computer for supporting a user to determine insurance, comprises a value-acquiring module for enabling the computer to acquire value information that indicates a value of an insured object; a premium distribution module for enabling the computer to determine a distribution of premium for the insured object using the value of the insured object.

According to a ninth aspect of the present invention, a method for adjusting a distribution of premiums of a plurality of insured objects, comprises acquiring a value of each insured object for the plurality of the insured objects; adjusting payment-limit-amounts of the plurality of the insured objects to the corresponding values of the insured objects when the corresponding payment-limit-amounts of the insured objects are greater than the values of the insured objects; and adjusting the distribution of premiums of the plurality of the insured objects according to the adjusted payment-limit-amounts.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 shows a system that includes an insurance-determination-supporting apparatus 200 of an embodiment of the present invention.

FIG. 2 shows a configuration of the insurance-determination-supporting apparatus 200 in FIG. 1.

FIG. 3 shows an example of a request research database 210 in FIG. 2.

FIG. 4 shows another example of the request research database 210.

FIG. 5 shows an example of the configuration of the statistics database 220 in FIG. 2.

FIG. 6 shows an example of a display of the display unit 410 of the user terminal 400 in FIG. 1.

FIGS. 7A, 7B, and 7C show an example of the operation of the compensation-request-acquiring unit 250 in FIG. 2.

FIGS. 8 and 9A-9B show another example of the operation of the compensation-request-acquiring unit 250.

FIGS. 10A-10C show another example of the operation of the compensation-request-acquiring unit 250.

FIG. 11 shows an example of the operation of the user terminal 400 and the insurance-determination-supporting apparatus 200 in FIG. 1.

FIG. 12 shows a detailed operation of the step 205 shown in FIG. 11.

FIG. 13 shows a detailed operation of the step 260 shown in FIG. 11.

FIG. 14 shows a configuration of hardware of the insurance-determination-supporting apparatus 200 according to an embodiment of the present invention.

### DETAILED DESCRIPTION

The invention will now be described based on the preferred embodiments, which do not intend to limit the scope of the present invention, but exemplify the invention. All of the features and the combinations thereof described in the embodiments are not necessarily essential to the invention.

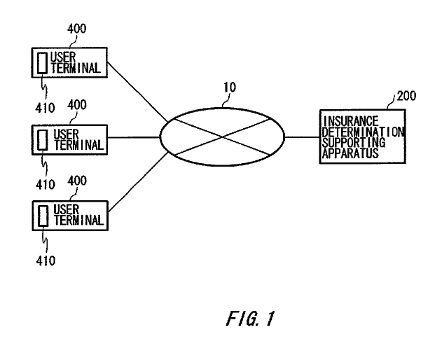

FIG. 1 shows a system that includes an insurance-determination-supporting apparatus 200 of an embodiment of the present invention. In the present system, the insurance-determination-supporting apparatus 200 is connected to a plurality of user terminals 400 via the Internet 10, for example.

The insurance-determination-supporting apparatus 200 acquires value information via the user terminals 400. The value information indicates the value of a plurality of insured objects, for which a customer requests insurance. As contemplated by the present invention, value of an object or objects includes an actual value based on objective criteria, such as market or replacement value, hereinafter “value information”, and value of the object or objects as perceived by the customer, i.e., a subjective or conscience value, hereinafter “conscience information”. However, “value” is not intended to be limited to the foregoing and may include any information that is consistent with the objectives and functions of the present invention.

The insurance-determination-supporting apparatus 200 also acquires a request for compensation of the customer for damage caused on the plurality of he insured objects. More specifically, the insurance-determination-supporting apparatus 200 acquires, as described hereinafter, the customer's subjective expectation of damage compensation for an object or objects based upon the customer's personal evaluation of the object or objects.

Each user terminal 400 has a display unit 410 that displays input screen data for acquiring the request for compensation from the customer.

The insurance-determination-supporting apparatus 200 supports the customer to determine insurance by determining the distribution of premium for a plurality of insured objects using at least one of the value of an insured object and the request for compensation of the customer. For example, the insurance-determination-supporting apparatus 200 determines the ratio of distribution of a premium budget for the plurality of insured objects using at least one of the value of the insured object and the request for compensation.

Moreover, the insurance-determination-supporting apparatus 200 acquires value information together with the above-mentioned request for compensation of the customer when the customer requests insurance for one insured object. Then, the insurance-determination-supporting apparatus 200 determines a recommended premium using the value of the insured object and the request for compensation. The recommended premium is a distribution of the premium for the insured object calculated from the premium budget limit of the customer.

For example, the insurance-determination-supporting apparatus 200 acquires at least one of the value information and the conscience information for the insured object, for which insurance is to be purchased by the customer, and for another insured object, which has been already insured by other insurance. Then, the insurance-determination-supporting apparatus 200 determines a distribution of the premium for the insured object according to the values of the insured object and the other insured object. In this case, the premium of the other insurance is a predetermined amount. Thus, the insurance-determination-supporting apparatus 200 determines a distribution of the premium only for the insurance object, which is to be insured by the customer.

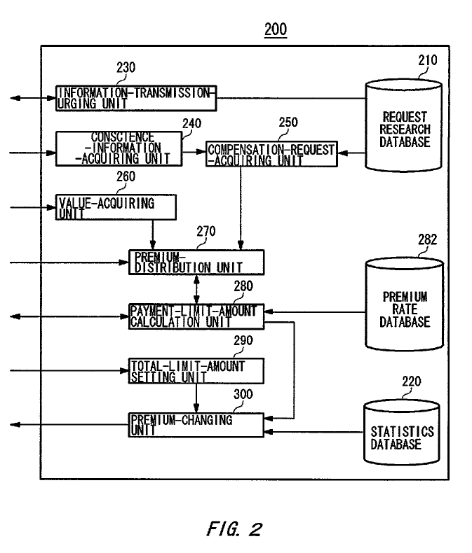

FIG. 2 shows a configuration of the insurance-determination-supporting apparatus 200. The insurance-determination-supporting apparatus 200 has a request research database 210, a premium rate database 282, and a statistics database 220 as databases. The insurance-determination-supporting apparatus 200 has an information-transmission-urging unit 230, a conscience-information-acquiring unit 240, a compensation-request-acquiring unit 250, a value-acquiring unit 260, a premium distribution unit 270, a payment-limit-amount calculation unit 280, a total-limit-amount setting unit 290, and a premium-changing unit 300 as functional units.

The request research database 210 stores at least a questionnaire, which is necessary for specifying the relative expectations of a request of the customer for compensation for each of a plurality of insured objects. The request research database 210 may store the above-mentioned questionnaire and the data for converting the answer to the questionnaire to compensation request information. The request research database 210 stores the questionnaire and the data for converting the answer to the questionnaire such that the questionnaire and the data correspond to each other.

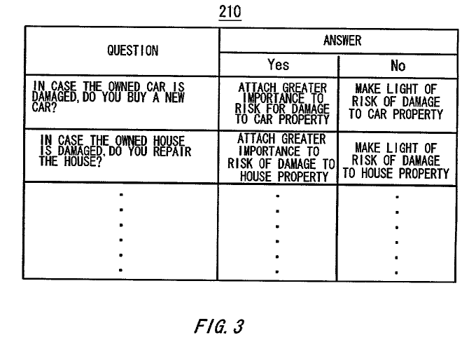

FIG. 3 shows an example of a request research database 210. In the present example, the request research database 210 has a question field and an answer field. The answer field has a Yes field and a No field. The question field stores the questionnaire that is to be shown to the customer via the user terminal 400. Specifically, the questionnaire stored in the question field is a questionnaire that asks the customer whether the customer takes a specific action when each type of the insured object is damaged.

The Yes field stores information for specifying whether the customer attaches greater importance to the risk to the specific property or makes light of the risk to the specific property when the customer answered as Yes to the questionnaire. The No field stores information for specifying whether the customer attaches greater importance to the risk to the specific property or makes light of risk to the specific property when the customer answered as No to the questionnaire. The information stored in the Yes field and No field may be a numerical value.

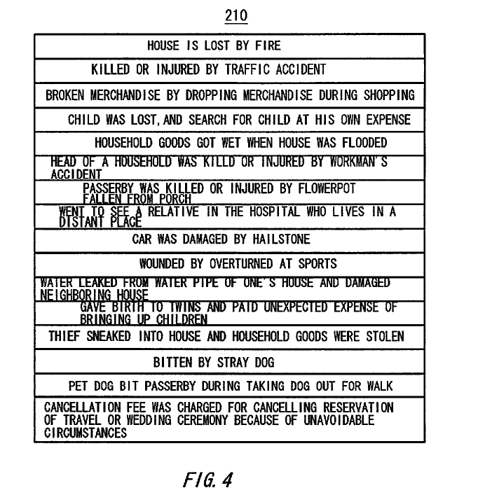

FIG. 4 shows another example of the request research database 210. In this example, the request research database 210 stores examples of risks, such as “a house is lost by fire”, as a questionnaire.

Referring to FIG. 2, the statistics database 220 is a database that stores a condition of occurrence of an insurance accident and insurance money paid for the insurance accident such that the condition and the insurance money correspond to each other.

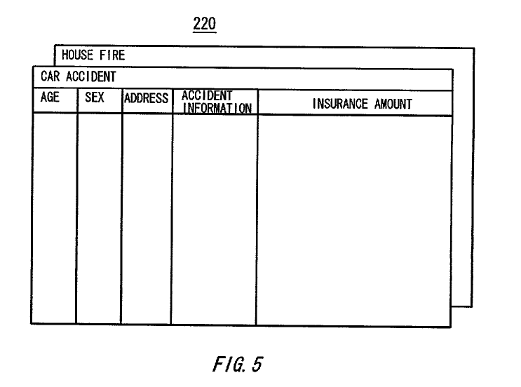

FIG. 5 shows an example of the configuration of the statistics database 220. In the present embodiment, the statistics database 220 has tables for each type of insurance accident such as a house fire and a car accident and so on. Each table has an age field, a sex field, an address field, an accident information field, and an insurance amount field, and so on.

The accident information field stores information, which is used for calculating the probability that the insured object of the customer will meet with an insurance accident, among the information related to the accident that was the cause of the payment of the insurance money. For example, the accident information field of the table related to the car accident stores information such as whether the insured person is a pedestrian, or the person rode a bicycle or motorcycle. The insurance amount field stores the amount of insurance money paid for the insurance accident.

The configuration of the statistics database 220 is not limited to the configuration shown in FIG. 5. The main part of the statistics database 220 may be configured by a statistics database that stores dynamic trends in a population, a statistics database that stores statistics of an insurance accident, and a statistics database that stores a population of people who have insurance.

Referring again to FIG. 2, the information-transmission-urging unit 230 acquires a questionnaire from the request research database 210 and sends input screen data to the user terminal 400, when the information-transmission-urging unit 230 receives the user's access information. The input screen data includes a questionnaire, which is acquired from the request research database 210, and a display, which urges the user to transmit an answer for the questionnaire as conscience information.

That is, the information-transmission-urging unit 230 urges the user to transmit the conscience information by displaying the input screen, which includes the questionnaire of the request research database 210 and a display that urges the user to answer the questionnaire, on the user terminal 400. The conscience information is information which is necessary for specifying what kind of conscience or expectations the customer has for the property of the plurality of insured objects. The conscience information includes a plurality of answers for a plurality of questions. Here, as a specific example of the display for urging the user to answer, the input screen includes an answer input column, into which the customer can input the answer.

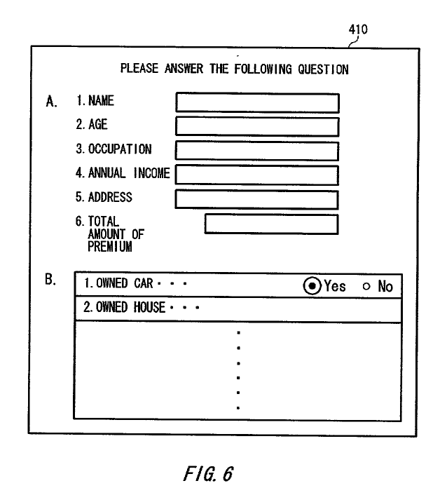

FIG. 6 shows an example of a display of the display unit 410 of the user terminal 400. In the present embodiment, the display unit 410 displays the input screen based on input screen data which is received from the information-transmission-urging unit 230.

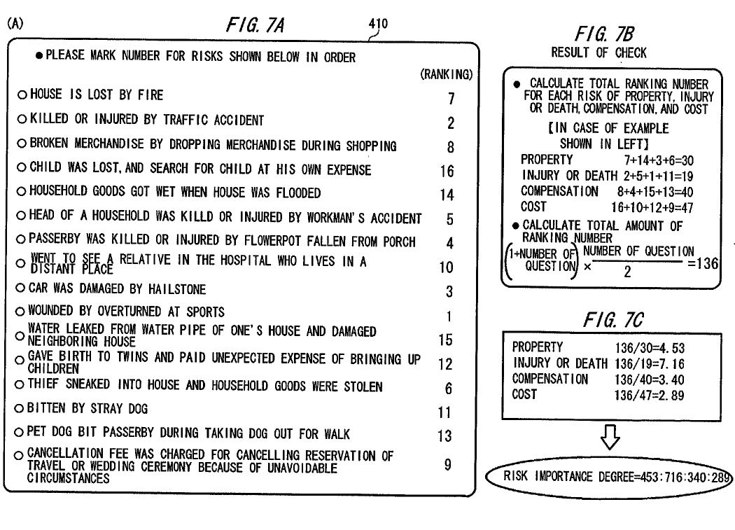

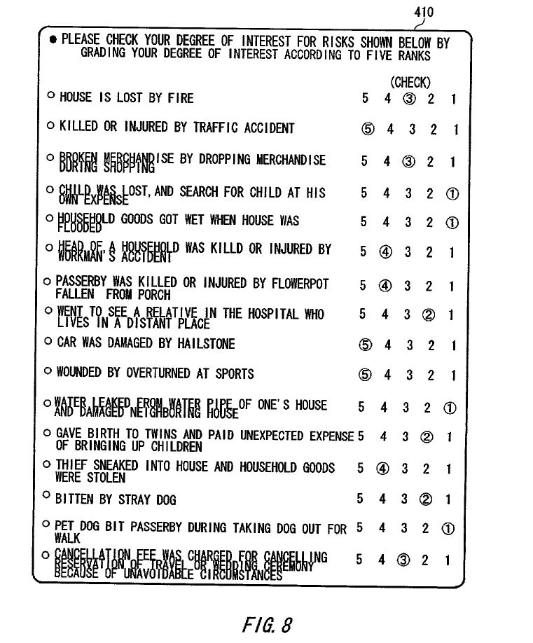

The display unit 410 displays text fields, in which the customer inputs a name, an age, an occupation, an annual income, an address, and a total amount of premium and so on. The display unit 410 also displays examples of risks stored in the request research database 210 as shown in FIG. 4. The display unit further displays a column, in which the user inputs rankings for the displayed risk examples (See FIGS. 7 and 8), and so on. The input screen may include information which is not mentioned in the present embodiment.

Referring to FIG. 2, the conscience-information-acquiring unit 240 acquires the answer to the questionnaire, which is sent to the user by the information-transmission-urging unit 230, from the user terminal 400 as the conscience information. The conscience-information-acquiring unit 240 transmits the acquired conscience information to the compensation-request-acquiring unit 250.

The compensation-request-acquiring unit 250 quantitatively calculates a risk-importance-degree using the received conscience information when the compensation-request-acquiring unit 250 receives the conscience information from the conscience-information-acquiring unit 240. The risk-importance-degree indicates which of the insured objects the customer thinks are important. The compensation-request-acquiring unit 250 then transmits the calculated risk-importance-degree as compensation request information to the premium-distribution unit 270.

FIGS. 7A, 7B, and 7C show an example of the operation of the compensation-request-acquiring unit 250 when the request research database 210 has a configuration as shown in FIG. 4. In the present embodiment, as shown in FIG. 7A, the customer ranks by number each risk example stored in the request research database 210 according to the interest of the customer for each risk, via the user terminal 400. The order of the interest of the customer for each risk is the order of the degree of importance attached by the customer to each risk. The customer then transmits the rank information, which indicates the rank numbers ranked by the customer, to the insurance-determination-supporting apparatus 200 as conscience information.

As shown in FIG. 7B, the compensation-request-acquiring unit 250 then classifies the rank numbers, which are received via the conscience-information-acquiring unit 240, into each type of risk and calculates the total value of the rank numbers for each type of risk. Here, each risk is classified into risk related to a property such as house, a car, a risk related to a person such as injury or death, a risk related to a compensation for damage to another person, and a risk related to a temporal expense, for example.

Then, as shown in FIG. 7C, the compensation-request-acquiring unit 250 divides the total values of the rank numbers of all the calculated risks by the total values of the rank numbers classified and calculated for each type of risk. That is, the compensation-request-acquiring unit 250 quantitatively calculates the risk-importance-degree of the customer by calculating the ratio of the multiplicative inverse of each total value of the rank numbers, which is determined by calculating the total value of the risk numbers for each type of risk.

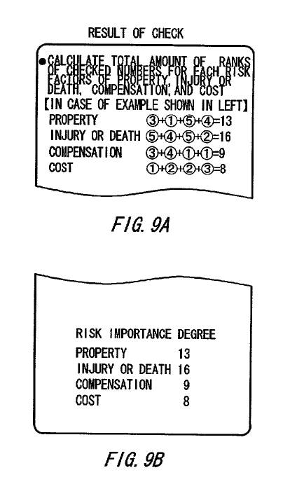

FIGS. 8 and 9A-9B show another example of the operation of the compensation-request-acquiring unit 250 when the request research database 210 has a configuration shown in FIG. 4. In the present embodiment, as shown in FIG. 8, the customer evaluates the degree of interest for each risk example, which is the importance degree for each risk example, stored in the request research database 210, via the user terminal 400. The customer then transmits evaluation information, which indicates the result of the evaluation, to the insurance-determination-supporting apparatus 200.

Specifically, the customer grades the importance degree according to five predetermined ranks and transmits the graded ranking numbers to the insurance-determination-supporting apparatus 200 as the evaluation information for each risk example.

As shown in FIG. 9A, the compensation-request-acquiring unit 250 classifies the graded ranking numbers, which are received via the conscience-information-acquiring unit 240, into each type of risk and calculates the total values of the ranking numbers for each type of risk. Here, the types of risks are the same as that of the example shown in FIG. 7.

Then, as shown in FIG. 9B, the compensation-request-acquiring unit 250 quantitatively calculates the risk-importance-degree of the customer by calculating the ratio of the calculated total values of the ranking numbers.

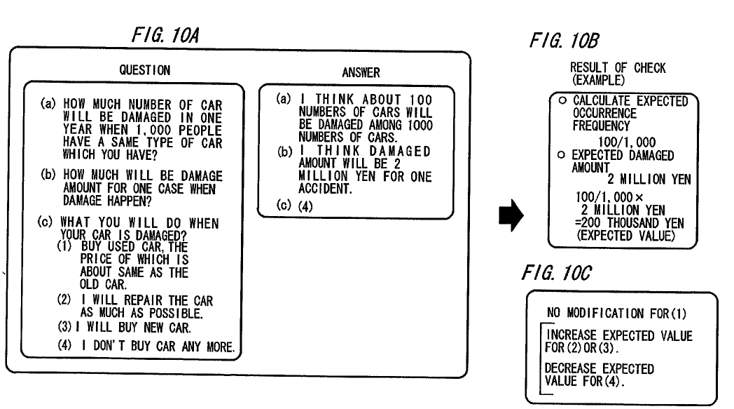

FIGS. 10A-10C show another example of the operation of the compensation-request-acquiring unit 250. As shown in FIG. 10A, the customer reads the questions stored in the request research database 210 via the user terminal 400. The customer then transmits the answers to the questions stored in the request research database 210 to the insurance-determination-supporting apparatus 200 as the conscience information.

The questions stored in the request research database 210 include asking the customer about how frequently an insurance accident will occur. The questions stored in the request research database 210 also include asking the customer the amount of damage for one case of the insurance accident. The questions stored in the request research database 210 further include asking the customer about the kind of action the customer will take for the insured object after the insurance accident happens.

That is, the data received by the compensation-request-acquiring unit 250 as the customer's answers include an expected occurrence frequency, an expected damage amount, and an expected action. The expected occurrence frequency is an expected frequency of occurrence of the insurance accident. The expected action is an action, which is expected to be taken by the customer, for the insured object after the insurance accident occurs.

Then, the compensation-request-acquiring unit 250 acquires compensation request information using the expected occurrence frequency and the expected damage amount of the insurance accident. As an example, as shown in FIG. 10B, the compensation-request-acquiring unit 250 multiplies the acquired expected occurrence frequency by the expected damage amount to acquire an expected value as the compensation request information. This expected value is an amount recognized by the customer as potentially the value of the insured object.

Furthermore, the compensation-request-acquiring unit 250 acquires the compensation request information using the expected action when the compensation-request-acquiring unit 250 receives the expected action of the customer. As an example, as shown in FIG. 10C, the compensation-request-acquiring unit 250 modifies the expected value using the expected action and acquires the modified expected value as the compensation request information.

For example, in case the insured object is a car, and the customer expects that he will buy a used car, the price of which is about the same as the old car, as shown in (c) (1) in FIG. 10A, the compensation-request-acquiring unit 250 does not modify the expected value. In case the insured object is a car, and the customer expects that he will repair the car or buy a new car, as shown in (c)(2) and (c)(3) in FIG. 10A, the compensation-request-acquiring unit 250 increases the expected value. In case the insured object is a car, and the customer expects that he will not buy a car, as shown in (c)(4) in FIG. 10A, the compensation-request-acquiring unit 250 decreases the expected value.

Referring again to FIG. 2, the value-acquiring unit 260 acquires value information, which is a value of each of the plurality of insured objects owned by the customer. Specifically, the value-acquiring unit 260 acquires the annual income, the type and the model of the car, the address, and the layout of the house of the customer as the value information. The value-acquiring unit 260 calculates value of each of the plurality of insured objects using the acquired value information. For example, the value-acquiring unit 260 may acquire value information from a database that stores information of the customer or may acquire the value directly from the customer.

The premium-distribution unit 270 determines a distribution ratio of the premium using at least one of the value of the insured object, which is transmitted from the value-acquiring unit 260, and the compensation request information, which is transmitted from the compensation-request-acquiring unit 250.

Specifically, the premium-distribution unit 270 calculates a product of the value, which is transmitted from the value-acquiring unit 260, by the risk-importance-degree, which is transmitted from the compensation-request-acquiring unit 250, for each type of risk. The premium-distribution unit 270 then calculates the ratio of the above-mentioned products as a premium distribution ratio.

Furthermore, the premium-distribution unit 270 may calculate the ratio of the risk-importance-degrees as a premium distribution ratio. Furthermore, the premium-distribution unit 270 may calculate the ratio of the values of the insured objects as the premium distribution ratio. Furthermore, the premium-distribution unit 270 may calculate the ratio of the expected values as the premium distribution ratio when the premium-distribution unit 270 receives the expected values as the compensation request information.

The premium-distribution unit 270 receives the total amount of the premium, which is provided by the customer via the user terminal 400 (note FIG. 6), and distributes the received total amount of the premium to the calculated premium distribution ratio to calculate the premium for each of the plurality of insured objects.

The payment-limit-amount calculation unit 280 calculates the payment-limit-amount of the insurance money to be paid for each insured object. The payment-limit-amount calculation unit 280 calculates the payment-limit-amount using each premium, which is received from the premium-distribution unit 270, and the premium rate, which is received from the premium rate database 282. The premium rate database 282 stores the information related to the insured objects and the premium rate of each kind of insurance such that the information related to the insured objects and the premium rates correspond to each other. The payment-limit-amount calculation unit 280 transmits the calculated payment-limit-amounts and the premiums to the user terminal 400.

Moreover, the payment-limit-amount calculation unit 280 transmits the information that confirms whether the customer requests to set the total-limit-amount. Here, the total-limit-amount is an upper limit amount of the insurance money to be paid for the plurality of insured objects when damage occurs for the plurality of insured objects owing to the same insurance accident. For example, when the customer causes a traffic accident, insurance money is paid for damage to the car, medical expense of the driver, compensation to the victims, and so on. The total-limit-amount sets the upper limit for the total amount of the above-mentioned insurance money.

When the customer requests, via the user terminal 400, to set the total-limit-amount, the payment-limit-amount calculation unit 280 transmits the calculated payment-limit-amount and premiums to the premium changing unit 300.

Moreover, the payment-limit-amount calculation unit 280 reduces the payment-limit-amount to adjust the payment-limit-amount to the value of the insured object when the calculated payment-limit-amount is greater than the value of the insured object, which is calculated by the value-acquiring unit 260. The payment-limit-amount calculation unit 280 then calculates the premium, which corresponds to the reduced amount of the payment-limit-amount.

For example, the payment-limit-amount calculation unit 280 multiplies the reduced amount of the payment-limit-amount by the corresponding premium rate to obtain the premium. The payment-limit-amount calculation unit 280 then outputs the calculated premium and information that specifies the insured object, to the premium-distribution unit 270.

In this case, the premium-distribution unit 270 deducts the premium, which is received from the payment-limit-amount calculation unit 280, from the premium of the insured object. The premium-distribution unit 270 then redistributes the premium, which corresponds to the reduced amount of the premium of the insured object, to the insured objects other than the insured object, the premium of which is reduced. The distributing rate in this case may be the same as the initial premium distribution rate.

The total-limit-amount setting unit 290 acquires the total-limit-amount, which is requested by the customer, from the user terminal 400. The total-limit-amount setting unit 290 then transmits the acquired total-limit-amount to the premium-changing unit 300.

The premium-changing unit 300 modifies the premium, which is received from the payment-limit-amount calculation unit 280, using the data stored in the statistics database 220, and the total-limit-amount, which is acquired from the total-limit-amount setting unit 290. The premium-changing unit 300 transmits the modified premium to the user terminal 400.

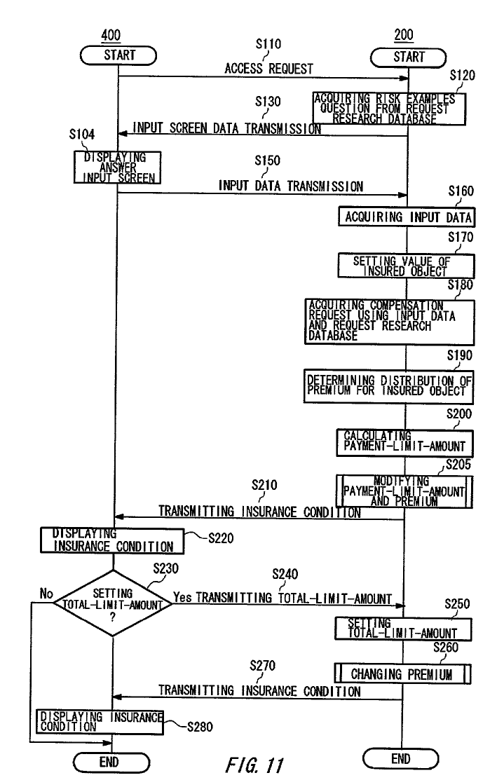

FIG. 11 shows an example of the operation of the user terminal 400 and the insurance-determination-supporting apparatus 200. First, the user terminal 400 requests the insurance-determination-supporting apparatus 200 for access to the insurance-determination-supporting apparatus 200 (S110). Then, the information-transmission-urging unit 230 of the insurance-determination-supporting apparatus 200 acquires the risk examples from the request research database 210 (S120).

The information-transmission-urging unit 230 transmits the input screen data, which includes the acquired risk examples, to the user terminal 400 (S130). The user terminal 400 displays the input screen, such as shown in FIG. 6, to urge the customer to input the predetermined data when the user terminal 400 receives the input screen data (S140). The user terminal 400 then transmits the input data, which is input according to the customer's instruction, to the insurance-determination-supporting apparatus 200 (S150).

When the insurance-determination-supporting apparatus 200 acquires the input data from the user terminal 400 (S160), the insurance-determination-supporting apparatus 200 acquires and sets the value of each insured object using the value-acquiring unit 260 (S170). The insurance-determination-supporting apparatus 200 also calculates the compensation request of the customer from the input data using the compensation-request-acquiring unit 250 and the request research database 210 (S180).

The insurance-determination-supporting apparatus 200 then determines the distribution of the premium for the plurality of insured objects using the premium-distribution unit 270 (S190). The insurance-determination-supporting apparatus 200 then calculates the payment-limit-amount using the payment-limit-amount calculation unit 280 (S200). Next, the insurance-determination-supporting apparatus 200 modifies the premium and the payment-limit-amount using the premium-distribution unit 270 and the payment-limit-amount calculation unit 280 (S205). The insurance-determination-supporting apparatus 200 then transmits the terms or conditions of the insurance, which include the modified payment-limit-amount and the distributed premium, to the user terminal 400 (S210).

The user terminal 400 displays the insurance conditions received from the insurance-determination-supporting apparatus 200 (S220). The user terminal 400 asks the customer to confirm whether or not the customer requests setting of the total-limit-amount. If the customer requests to set the total-limit-amount (S230, Yes), the user terminal 400 transmits the total-limit-amount, which is set by the customer, to the insurance-determination-supporting apparatus 200 (S240). If the customer does not request to set the total-limit-amount (S230, No), the user terminal 400 and the insurance-determination-supporting apparatus 200 finish the operation.

The insurance-determination-supporting apparatus 200 sets the total-limit-amount, using the premium-changing unit 300, when the insurance-determination-supporting apparatus 200 receives the request for setting the total-limit-amount from the user terminal 400 (S250). The insurance-determination-supporting apparatus 200 changes the premium using the premium-changing unit 300 (S260). The insurance-determination-supporting apparatus 200 then transmits the insurance conditions, which include the changed premium, to the user terminal 400 (S270). The user terminal 400 then displays the received insurance conditions (S280) and finishes the operation.

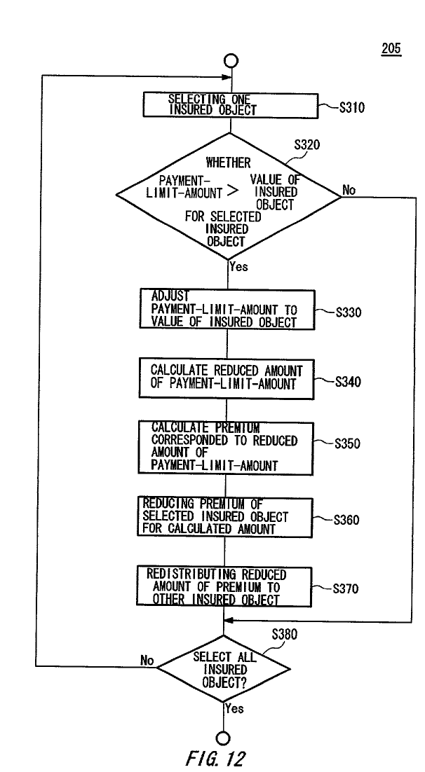

FIG. 12 shows a detailed operation of Step 205 shown in FIG. 11. The payment-limit-amount calculation unit 280 selects one insured object (S310). Next, the payment-limit-amount calculation unit 280 compares the payment-limit-amount of the insured object with the value of the insured object (S320).

When the payment-limit-amount is greater than the value of the insured object for the selected insured object (S320, Yes), the payment-limit-amount calculation unit 280 adjusts the payment-limit-amount of the insured object to the value of the insured object (S330). The payment-limit-amount calculation unit 280 then calculates the amount by which the payment-limit-amount is reduced (S340) and calculates the amount of premium to be reduced, which corresponds to the reduced amount of the payment-limit-amount (S350). The payment-limit-amount calculation unit 280 then transmits information which specifies the insured object and information which indicates the calculated reduced premium, to the premium-distribution unit 270.

When the premium-distribution unit 270 receives the above-mentioned two types of information from the payment-limit-amount calculation unit 280, the premium-distribution unit 270 reduces the premium of the insured object, which corresponds to the received information, by the amount of the received reduced premium (S360). The premium-distribution unit 270 then redistributes the adjusted amount of the premium to other insured objects, other than the insured object the premium of which is reduced (S370).

The insurance-determination-supporting apparatus 200 performs the operations explained above for all the insured objects by repeating the above-mentioned operations until the payment-limit-amount calculation unit 280 has selected all the insured objects (S380).

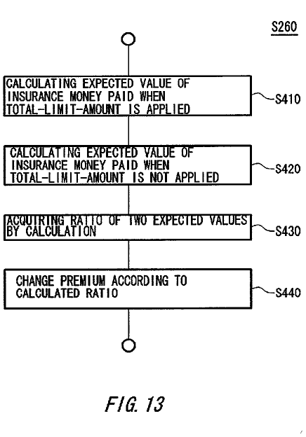

FIG. 13 shows a detailed operation of Step 260 shown in FIG. 11. The premium-changing unit 300 calculates the expected value of the insurance money, which is to be paid when the total-limit-amount is applied, using the statistics database 220 (S410). The premium-changing unit 300 also calculates the expected value of the insurance money, which is paid when the total-limit-amount is not applied (S420). The premium changing unit 300 then calculates the ratio between the two expected values (S430) and changes the premiums so that the ratio of the expected values and the ratio of the premiums match (S440).

Therefore, the customer can properly distribute the premium for the plurality of insured objects using the insurance-determination-supporting apparatus 200. Furthermore, the insurance-determination-supporting apparatus 200 can prevent the customer carrying excessive insurance by setting the total-limit-amount, which is a limit amount of the total value of the insurance money to be paid for the same cause.

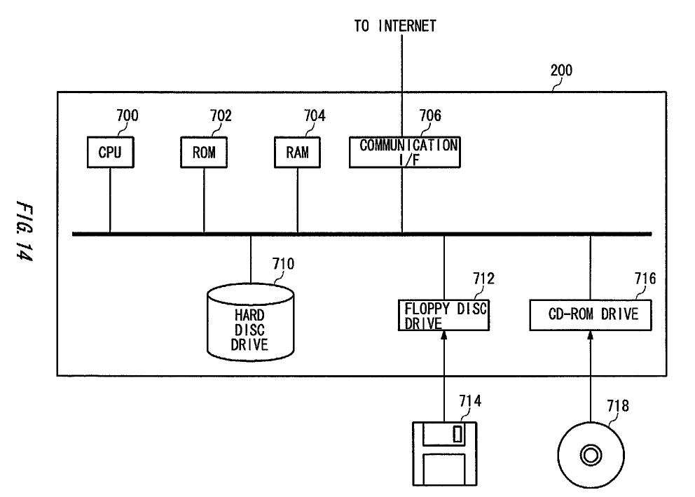

FIG. 14 shows a configuration of hardware of the insurance-determination-supporting apparatus 200 according to one embodiment of the present invention. The insurance-determination-supporting apparatus 200 comprises a CPU 700, a ROM 700, a RAM 704, and a communication interface 706. The CPU 700 operates based on the program stored in the ROM 702 and the RAM 704. The communication interface 706 communicates outside the insurance-determination-supporting apparatus 200 via a communication network, such as the Internet or an Intranet. The hard disk drive 710, which is one example of the storing apparatus, stores setting information and a program that operates the CPU 700.

The floppy disk drive 712 reads out data or program from the floppy disk 714 and provides it to the CPU 700. The CD-ROM drive 716 reads out data or program from the CD-ROM 718 and provides it to the CPU 700. The communication interface 706 transmits the data while connected to an information communication network, such as the Internet.

The software executed by the CPU 700 may be stored in a recording medium such as the floppy disk 714 or the CD-ROM 718 and provided to the user as such. The software stored in the recording medium may be compressed or uncompressed. The software stored in the recording medium may be installed to the hard disk drive 710 from the recording medium and read out to the RAM 704 and executed by the CPU 700.

The software, which is stored in the recording medium and provided to the user and is installed to the hard disk drive 710, comprises an information transmission urging module, a conscience information acquiring module, a compensation request acquiring module, a value acquiring module, a premium distribution module, a payment-limit-amount calculation module, a total-limit-amount setting module, and a premium changing module as functional components. Because the processes executed by the CPU according to the instructions of each of the above-mentioned modules are the same as the processes executed by the functions and operations of the corresponding units in the insurance-determination-supporting apparatus 200 shown in FIG. 2, an explanation here is abbreviated.

The floppy disk 714 or the CD-ROM 718 shown in FIG. 14, which are examples of a recording medium, can store a part or all of the functions of the insurance-determination-supporting apparatus 200 explained in all of the present embodiments.

The program may be directly read out from the recording medium to the RAM 704 and executed by the CPU 700. The program also may be just installed into the hard disk drive 710 and read out to the RAM 704 and executed by the CPU 700. Furthermore, the above-mentioned program may be stored in a single recording medium or stored in a plurality of recording media. Moreover, the modules stored in the recording medium may provide each function by cooperating with an operating system. For example, the modules may request the operation system to perform a part or all of the functions and provide functions based on the responses sent from the operation system.

An optical recording medium such as DVD, a magnetic recording medium, and a photo magnetic recording medium, tape medium, or a semiconductor memory such as an IC card or memory card can be used as a recording medium. Moreover, a storing apparatus such as the hard disk drive 710 or the RAM 704 provided in a server system, which is connected to a private communication network or the Internet, may be used as a recording medium, and the program may be provided to the insurance-determination-supporting apparatus 200 via the communication network.

According to the present invention, a customer can properly distribute a total premium for insured objects. Furthermore, the insurance-determination-supporting apparatus of the present invention can prevent the customer carrying excessive insurance by setting a total-limit-amount, which is a limit amount for the insurance money to be paid for the same cause.

Although the present invention has been described by way of exemplary embodiments, it should be understood that those skilled in the art might make many changes and substitutions without departing from the spirit and the scope of the present invention, which is defined only by the appended claims.

1. An apparatus for supporting a user in determining insurance to compensate for damage to an object of the insurance, comprising:
a compensation-request-acquiring unit for acquiring compensation request information that has a correlation with an expectation of the user for compensation for damage caused on said insured object; and
a premium-distribution unit for determining a distribution of premium for said insured object using said compensation request information acquired by said compensation-request-acquiring unit.

2. An apparatus as claimed in claim 1, further comprising a payment-limit-amount calculation unit for calculating a payment-limit-amount for said insured object using said distribution of said premium determined by said premium-distribution unit.

3. An apparatus as claimed in claim 2, further comprising:
a premium rate database that stores a premium rate of a plurality of said insured objects; and
said payment-limit-amount calculation unit calculates said payment-limit-amount for said plurality of said insured objects using said distribution of said premium and said premium rate stored in said premium rate database.

4. An apparatus as claimed in claim 1, further comprising:
a total limit amount setting unit for setting a total limit amount, which is an upper limit of insurance money to be paid for a plurality of said insured objects because of a same cause when there are said plurality of said insured objects; and
a premium-changing unit for changing each distributed premium for said plurality of said insured objects using said total limit amount set by said total limit amount setting unit when there are said plurality of said insured objects.

5. An apparatus as claimed in claim 4, wherein: said premium changing unit acquires a ratio between a first expected value of insurance money, which is paid when said total limit amount is applied, and a second expected value of insurance money, which is paid when said total limit amount is not applied, and changes said premium using said ratio.

6. An apparatus as claimed in claim 1, further comprising:
an information-transmission-urging unit that displays a screen for urging the user to transmit conscience information, which is used to specify said expectation of the user for said insured object; and
a conscience-information-acquiring unit for acquiring said conscience information from the user; and
said compensation-request-acquiring unit acquires said compensation request information using said conscience information of the user.

7. An apparatus as claimed in claim 6, wherein:
said information-transmission-urging unit displays a questionnaire related to said insured object on said first screen and displays a second screen that urges the user to transmit an answer for said questionnaire; and
said conscience-information-acquiring unit receives said answer for said questionnaire as said conscience information.

8. An apparatus as claimed in claim 7, wherein:
said information-transmission-urging unit uses risk examples that describe examples of damages to said insured object as said questionnaire; and
said conscience-information-acquiring unit receives rank information that ranks said risk examples according to a degree of importance of each risk as said answer.

9. An apparatus as claimed in claim 7, wherein:
said information-transmission-urging unit uses risk examples that describe examples of damages to said insured object as said questionnaire; and
said conscience-information-acquiring unit receives evaluation information that evaluates a degree of importance of said risk examples as said answer.

10. An apparatus as claimed in claim 8, wherein:
said conscience-information-acquiring unit acquires an expected occurrence frequency, which is a frequency of occurrence of an insurance accident estimated by the user, and an expected damage amount estimated by the user for one insurance accident, as said conscience information; and
said compensation-request-acquiring unit acquires said compensation request information using said expected occurrence frequency and said expected damage amount.

11. An apparatus as claimed in claim 10, wherein:
said conscience-information-acquiring unit further acquires an expected action, which is expected to be performed by the user related to said insured object after said insurance accident happens; and
said compensation-request-acquiring unit acquires said compensation request information using said expected action.

12. An insurance-determination-supporting apparatus for supporting a user in determining insurance for an object, comprising:
a compensation-request-acquiring unit for acquiring rank information that includes a ranking of risk of the insured object ranked by the user according to a degree of importance of a risk; and
a premium-distribution unit for determining a distribution of premium for said insured object using said rank information acquired by said compensation-request-acquiring unit.

13. An apparatus for supporting a user to determine insurance, comprising:
a compensation-request-acquiring unit for acquiring evaluation information that includes a degree of importance of risks for an insured object evaluated by the user; and
a premium-distribution unit for determining a distribution of premium for said insured object using said evaluation information acquired by said compensation-request-acquiring unit.

14. An insurance-determination-supporting apparatus for supporting a user to determine insurance, comprising:
a compensation-request-acquiring unit for acquiring an expected occurrence frequency, which is a frequency of occurrence of an insurance accident on an insured object estimated by the user, and an expected damage amount for one insurance accident estimated by the user; and
a premium-distribution unit for determining a distribution of premium for said insured object using said expected occurrence frequency and said expected damage amount acquired by said compensation-request-acquiring unit.

15. An apparatus for supporting a user to determine insurance, comprising:
a value-acquiring unit for acquiring value information that indicates a value of an insured object; and
a premium-distribution unit for determining a distribution of premium for said insured object using said value acquired by said value-acquiring unit.

16. An apparatus as claimed in claim 115, further comprising a payment-limit-amount calculation unit for calculating a payment-limit-amount for said insured object from said distributed premium.

17. An apparatus as claimed in claim 16, further comprising:
a premium rate database that stores a premium rate of a plurality of said insured objects; and
said payment-limit-amount calculation unit calculates said payment-limit-amount for said plurality of said insured objects using said distribution of said premium and said premium rate stored in said premium rate database.

18. An apparatus as claimed in claim 16, wherein:
said payment-limit-amount calculation unit adjusts said payment-limit-amount to said value of said insured object when said payment-limit-amount calculated by said payment-limit-amount calculation unit is greater than said value of said insured object; and
said premium-distribution unit deducts an excess premium, which corresponds to an amount of said payment-limit-amount that is reduced, from said premium of said insured object, when said payment-limit-amount calculation unit judges that said payment-limit-amount calculated by said payment-limit-amount calculation unit is greater than said value of said insured object.

19. An apparatus as claimed in claim 18, wherein: said premium-distribution unit redistributes said deducted amount of said excess premium to other insured objects, except said insured object, according to a ratio of said premium that has already been distributed, when there are a plurality of said insured objects.

20. An apparatus as claimed in claim 15, further comprising:
a total limit amount setting unit for setting a total limit amount, which is an upper limit of insurance money to be paid for a plurality of said insured objects because of a same cause, when there are said plurality of said insured objects; and
a premium-changing unit for changing each distributed premium of said plurality of said insured objects using said total limit amount set by said total limit amount setting unit, when there are said plurality of said insured objects.

21. An apparatus as claimed in claim 20, wherein: said premium-changing unit acquires a ratio between a first expected value of insurance money, which is to be paid when said total limit amount is applied, and a second expected value of insurance money, which is to be paid when said total limit amount is not applied, and changes said premium using said ratio.

22. An apparatus for supporting a user to determine insurance, comprising:
a value-acquiring unit for acquiring value information that indicates a value of an insured object;
a compensation-request-acquiring unit for acquiring compensation request information that has a correlation with an expectation of the user for compensation for damage caused to said value of said insured object; and
a premium-distribution unit for determining a distribution of premium for said insured object using said value acquired by said value-acquiring unit and said compensation request information acquired by said compensation-request-acquiring unit.

23. An apparatus as claimed in claim 22, further comprising a payment-limit-amount calculation unit for calculating a payment-limit-amount for said insured object from said distributed premium.

24. An apparatus as claimed in claim 23, wherein:
said payment-limit-amount calculation unit adjusts said payment-limit-amount to said value of said insured object when said payment-limit-amount calculated by said payment-limit-amount calculation unit is greater than said value of said insured object; and
said premium-distribution unit deducts an excess premium, which corresponds to an amount of said payment-limit-amount that is reduced, from said premium of said insured object, when said payment-limit-amount calculation unit judges that said payment-limit-amount calculated by said payment-limit-amount calculation unit is greater than said value of said insured object.

25. A premium distribution adjusting apparatus for adjusting a distribution of corresponding premiums of a plurality of insured objects, comprising:
a value-acquiring unit for acquiring value information, which indicates a value of an insured object, for said plurality of said insured objects;
a payment-limit-amount calculation unit for adjusting corresponding payment-limit-amounts of said plurality of said insured objects to said corresponding values of said insured objects when said payment-limit-amounts of said insured objects are greater than said values of said insured objects; and
a premium-distribution unit for adjusting said distribution of premiums of said plurality of said insured objects according to said adjusted payment-limit-amounts.

26. A method for supporting a user to determine insurance, comprising:
acquiring compensation request information that has a correlation with an expectation of the user for compensation for damage caused to an insured object;
determining a distribution of premium for said insured object using said compensation request information; and
notifying said distributed premium to the user.

27. A method as claimed in claim 26, further comprising: calculating a payment-limit-amount for said insured object using said distribution of said premium.

28. A method as claimed in claim 26, further comprising:
storing a premium rate of a plurality of said insured objects; and
calculating said payment-limit-amount for said plurality of said insured objects using said distribution of said premium and said stored premium rate.

29. A method as claimed in claim 26, further comprising:
setting a total limit amount, which is an upper limit of insurance money to be paid for a plurality of said insured objects because of a same cause when there are said plurality of said insured objects; and
changing each distributed premium for said plurality of said insured objects using said total limit amount, when there are said plurality of said insured objects.

30. A method as claimed in claim 26, further comprising:
displaying a screen for urging the user to transmit conscience information, which is used for specifying said expectation of the user for said insured object; and
acquiring said conscience information from the user; and
acquiring said compensation request information using said conscience information of the user.

31. A method for supporting a user to determine insurance, comprising:
acquiring value information that indicates a value of an insured object;
determining a distribution of premium for said insured object using said value; and
notifying said distributed premium to the user.

32. A method as claimed in claim 31, further comprising calculating a payment-limit-amount for said insured object from said distributed premium.

33. A method as claimed in claim 32, further comprising:
storing a premium rate of a plurality of said insured objects; and
calculating said payment-limit-amount for said plurality of said insured objects using said distribution of said premium and said stored premium rate.

34. A method as claimed in claim 31, further comprising:
setting a total limit amount, which is an upper limit amount of insurance money to be paid for a plurality of said insured objects because of a same cause when there are said plurality of said insured objects; and
changing each distributed premium for said plurality of said insured objects using said total limit amount, when there are said plurality of said insured objects.

35. A storing medium storing a program executable by a computer for supporting a user to determine insurance, comprising:
a compensation request acquiring module for enabling the computer to acquire compensation request information that has a correlation with an expectation of the user for compensation for damage caused on an insured object; and
a premium distribution module for enabling the computer to determine a distribution of premium for said insured object using said compensation request information.

36. A storing medium storing a program executable by a computer for supporting a user to determine insurance, comprising:
a value-acquiring module for enabling the computer to acquire value information that indicates a value of an insured object;
a premium distribution module for enabling the computer to determine a distribution of premium for said insured object using said value of the insured object.

37. A method for adjusting a distribution of premiums of a plurality of insured objects, comprising:
acquiring a value of each insured object for said plurality of said insured objects;
adjusting payment-limit-amounts of said plurality of said insured objects to said corresponding values of said insured objects when said corresponding payment-limit-amounts of said insured objects are greater than said values of said insured objects; and
adjusting said distribution of premiums of said plurality of said insured objects according to said adjusted payment-limit-amounts.
